(19) United States
(12) Patent Application Publication
(10) Pub. No.: US 2003/0000977 A1
(43) Pub. Date: Jan. 2, 2003

(54) Portable eyeglass holding device

(76) Inventors: Joseph R. Baldwin, Farmingdale, NY (US); Flavio Rivera, Brooklyn, NY (US)

Correspondence Address: COLLARD & ROE, P.C., 1077 Northern Boulevard, Roslyn, NY, 11576, US

(21) Appl. No.: 09/896,739

(22) Filed: Jun. 29, 2001

(51) Int. Cl. B60R 7/05; A45C 11/04

(52) U.S. Cl. 224/312; 206/5; 248/902

(57) ABSTRACT

The invention relates to a device for holding articles such as eyeglasses. This device includes a wire frame that contains three functional sections. The first section is a paper holding section, the second section is a snap on section for a visor and the third section is a clip on section for clipping eyeglasses onto the frame. The three functional sections of this device each contain a set of compression points, wherein all of these compression points are narrowed regions formed by two opposing inside faces of the wire frame or clip. The first set of compression points are disposed on an inside region of the first functional section. The second set of compression points are disposed on the second functional section. The wire frames are bent together so that informational papers can be slid therein. Because the device contains these compression points, this device can lock onto both the item that this device is secured to, and the article that secures to the device. In addition, this device can be compressed or expanded so that any one or all of the compression points can either be narrowed or expanded.

### BACKGROUND OF THE INVENTION

1. Field of the Invention

The invention relates to an eyeglass holder that is designed to clip onto other articles such as a visor to allow a user to hold the eyeglasses in place.

### SUMMARY OF THE INVENTION

The invention relates to a device for holding articles such as eyeglasses. This device includes a wire frame that contains two functional sections. The first section is a paper holding section, the second section is a snap on section for snapping onto a visor of an automobile such as a car or a truck. There is also a third functional section formed by a strip bent into a u-shaped clip.

The three functional sections of this device each contain at least one compression region wherein all of these compression regions are narrowed regions formed by two opposing inside faces of the wire frame or clip. The first set of compression regions are disposed on an inside region of the first functional section. The second set of compression regions are disposed on the second functional section. The third compression region is formed from the u-shaped clip. The wire frames are bent together so that informational papers can be slid therein.

Because the device contains these compression regions, this device can lock onto both the item that this device is secured to, and the article that secures to the device. In addition, this device can be compressed or expanded so that any one or all of the compression points can either be narrowed or expanded. In that way, the device is adjustable to meet the needs of the user.

### BRIEF DESCRIPTION OF THE DRAWINGS

Other objects and features of the present invention will become apparent from the following detailed description considered in connection with the accompanying drawings which disclose one embodiment of the present invention. It should be understood, however, that the drawings are designed for the purpose of illustration only and not as a definition of the limits of the invention.

In the drawings wherein similar reference characters denote similar elements throughout the several views:

FIG. 1 is a perspective view of the device for holding articles;

FIG. 2 is a front view of the device for holding articles;

FIG. 3 is a top view of the device for receiving articles;

FIG. 4 is a back view of the device for receiving articles;

FIG. 5 is a bottom view of the device for receiving articles; and

FIG. 6 is a side view of the device for receiving articles.

### DETAILED DESCRIPTION OF THE PREFERRED EMBODIMENT

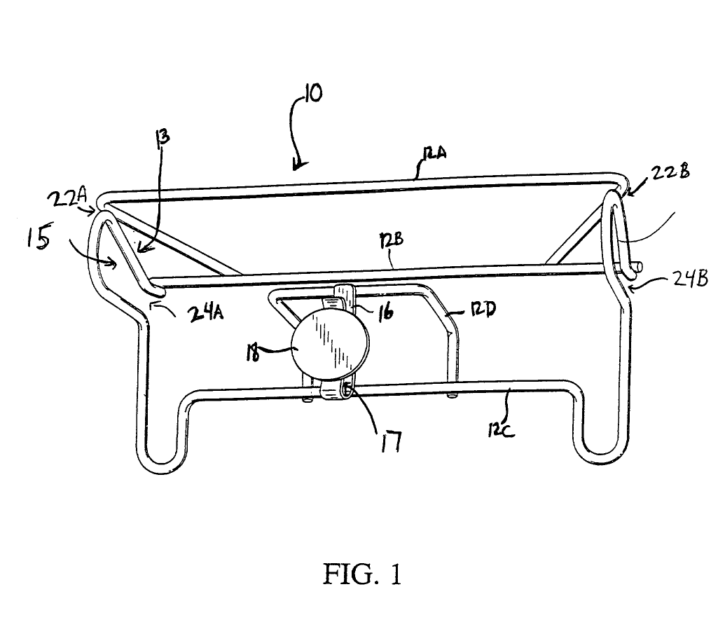

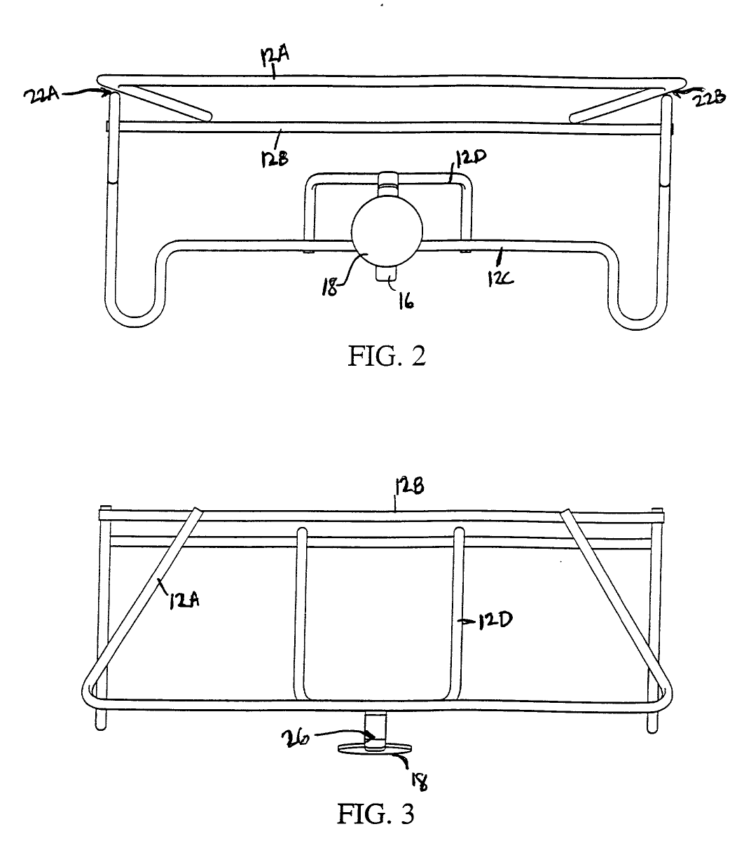

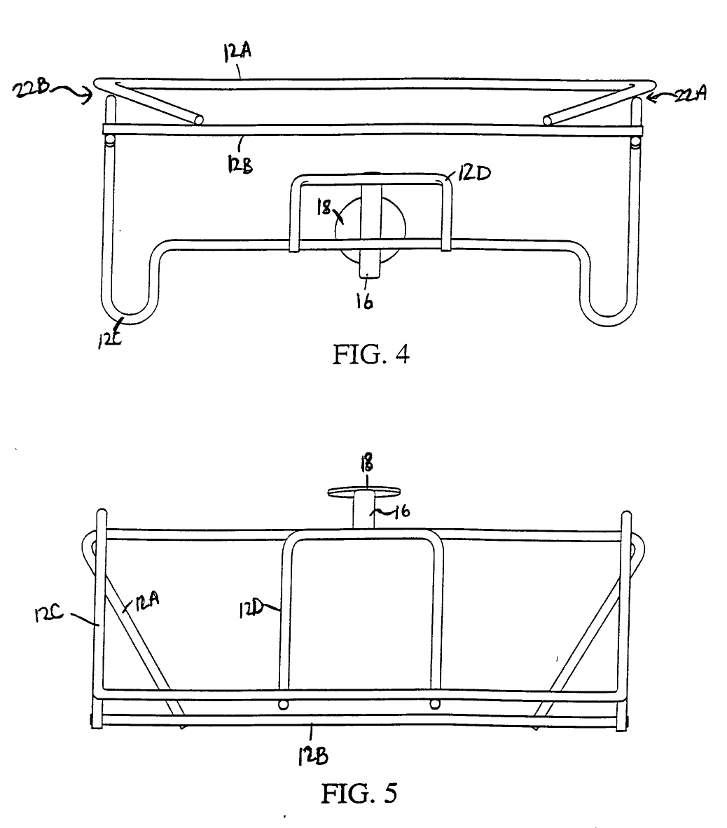

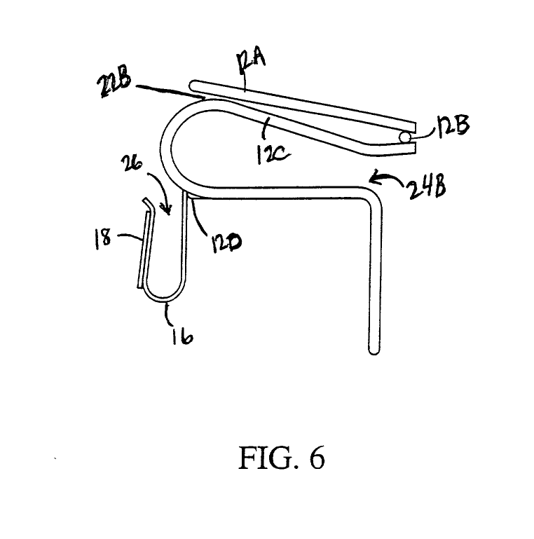

FIGS. 1-6 refer to a series of views of the invention wherein there is shown a device for holding articles 10, comprising a wire frame 12 formed from four separate pieces of wire 12a, 12b, 12c and 12d. The first wire piece 12a is shaped substantially triangular to form a top region. The second wire piece 12b, is shaped as a cross bar and is coupled to first wire piece 12a. The third wire piece 12c is coupled to second wire piece or cross bar 12b and forms a base which is bent to form a rounded multi-dimensional piece. The fourth wire piece 12d forms a second U-shaped cross bar, from which a unshaped clip 16 is coupled. Coupled to a front face of U-shaped clip 16 is a circular disc 18 which can be used to receive emblems or other decorations to decorate the device.

These wire pieces 12a, 12b, 12c, and 12d along with U-shaped clip define three functional sections 13, 15, and 17. First functional section 13 is a paper receiving section that is formed so that device 10 can be used to hold important papers such as a user's insurance information or registration papers. Second functional section is designed to attach to a user's visor. Third functional section is designed to allow a pair of sunglasses to snap inside U-shaped clip 16 creating a snug fit.

For example, if a user wanted to insert a lot of paper into device 10, the user could pull on wire 12 to expand a distance between opposed points on wire frames 12A and 12B forming compression regions and 22a and 22b. By expanding this region, the user could insert the paper into the frames for storage. The user could also mount device 10 onto a thick visor by adjusting the gap in compression regions 24A and 24B on wire frame 12B. To adjust this gap the user would simply pull or push on two different ends of wire frame 12B to pull this gap in compression regions 22A and 22B apart or together.

As shown, each of the functional sections 13, 15, and 17 are defined by an initial compression region. For example, functional section 13 is defined by compression regions 22a and 22b. Compression regions 22a and 22b are defined by a side of wire frame piece 12a and an opposing side of wire frame piece 12c. Compression regions 22a and 22b also include a flared opening 23 defined by a flared open portion 12c′ of wire frame piece 12c.

Regarding functional section 15, compression regions 24a and 24b are defined by bent wire frame 12c which is bent to form compression regions 24a and 24b and also have an initial flared opening 25 formed by a flared open portion 12c″ of wire frame piece 12c.

Functional section 17 is formed by U-shaped clip 16 which is coupled to wire frame 12D. U-shaped clip 16 is shaped to form a compression region 26 that also includes a flared region 27 as well. U-shaped clip is shaped to allow a bridge on a pair of glasses to be snapped in. There is also shown circular shaped disc 18 which is coupled to a front side of U-shaped clip 16. A user can adjust the opening 26 in clip 16 by pulling on clip 16 to create a larger opening.

In operation, the user would manually adjust compression regions 24A and 24B together to set the amount of distance and tension applied in compression regions 24A and 24B. Next, the user would slide device 10 onto a sun visor on an automobile such as a sports utility vehicle (SUV), a car, or a tractor trailer.

Next, the user would manually adjust compression regions 22a, and 22b to allow important papers to be slid into and held in functional section 13. Finally the user could manually adjust the size of compression region 26 to allow a pair of glasses or sunglasses to be slid inside. The user could easily slide device 10 off of a sun visor by simply taking hold of wire frame piece 12a and an opposite section of wire frame piece 12c and pulling device 10 off of a visor. The use could remove papers from functional section 13 by simply pulling these papers out, past compression regions 22a and 22b so that these papers simply slide out. Finally the user could remove a pair of glasses by snapping the bridge of the glasses past compression region 26 and pulling these glasses away from device 10.

Accordingly, while one embodiment of the present invention has been shown and described, it is to be understood that many changes and modifications may be made thereunto without departing from the spirit and scope of the invention as defined in the appended claims.

What is claimed is:

1. A device for holding articles comprising:
a) a wire frame comprising:
i) a paper receiving section having a set of compression points to allow paper to be fit snugly therein;
ii) a visor receiving section having a set of compression points to allow a visor to be fit snugly therein;
b) a clip coupled to said wire frame, said clip having a compression point, to allow a pair of glasses to be fit snugly therein.

2. The device as in claim 1, further comprising a disc shaped medallion coupled to said clip.

3. The device as in claim 1, wherein said wire frame comprises four separate wire pieces coupled together.

4. The device as in claim 3, wherein said paper receiving section is formed by a triangular shaped wire piece a wire cross bar coupled to said triangular shaped wire piece and a wire base section coupled to said wire cross bar.

5. The device as in claim 4, wherein said wire base section contains two loops that are bent to form said second functional section.

6. The device as in claim 3, further comprising a wire brace coupled to said wire base section wherein said clip is coupled to said wire brace.

7. The device as in claim 1, wherein said clip is U-shaped.
